(19) United States
(12) Patent Application Publication
(10) Pub. No.: US 2024/0316683 A1
(43) Pub. Date: Sep. 26, 2024

(54) A welding method

(71) Applicant: ArcelorMittal, Luxembourg (LU)

(72) Inventors: Zhifen WANG, Munster, IN (US); Alexis CHIOCCA, Metz (FR)

(21) Appl. No.: 18/579,606

(22) PCT Filed: Jun. 21, 2022
(86) PCT No.: PCT/IB2022/055737

§ 371 Date: Jan. 16, 2024

(30) Foreign Application Priority Data
Jul. 23, 2021 (WO) PCT/IB2021/056661

(51) Int. Cl. B23K 11/16; B23K 11/11; B23K 11/20; B23K 11/24; B23K 103/04; B23K 103/10

(52) U.S. Cl. CPC B23K 11/163; B23K 11/115; B23K 11/20; B23K 11/24; B23K 2103/04; B23K 2103/10

(57) ABSTRACT

A welding method for the manufacture of an assembly of at least two steel substrates spot welded together through at least one spot welded joint, including A. provision of substrates including a press hardened steel part obtained by press hardening of a steel sheet coated with an aluminium based coating, B. application of a spot-welding cycle with welding electrodes and a spot-welding power source applying a current, the cycle including: at least three pulsations, each having the same maximum pulsation current (Cp) applied through the substrates, each pulsation duration p being identical and set from 20 to 60 ms, each pulsation being followed by the same cooling time c set from 30 to 50 ms, wherein the welding parameter Wp value is at least 0.8, Wp being defined as Wp=(t×c)/p t being the average thickness of the substrate in mm, c being the cooling time in ms, p being the pulsation duration in ms.

The present invention relates to a welding method for the manufacture of an assembly of steel substrates spot welded together through at least one spot welded joint. The invention is particularly well suited for the manufacture of automotive vehicles.

### BACKGROUND

With a view of saving the weight of vehicles, it is known to use high strength steel sheets to achieve lighter weight vehicle bodies and improve crash safety. Hardened parts are also used notably to reduce the weight of vehicles. Indeed, the tensile strength of these steels is a minimum of 1200 MPa and can be up to 2500 MPa. Hardened parts can be coated with an aluminum-based or zinc-based coating having a good corrosion resistance and thermal properties.

Usually, the method for the manufacture of a coated hardened part comprises the following steps:
A) the provision of a steel sheet pre-coated with a metallic coating being conventional coating based on aluminum,
B) the cutting of the coated steel sheet to obtain a blank,
C) the thermal treatment of the blank at a high temperature to obtain a fully austenitic microstructure in the steel,
D) the transfer of the blank into a press tool,
E) the hot-forming of the blank to obtain a part,
F) the cooling of the part obtained at step E) in order to obtain a microstructure in steel being martensitic or martensito-bainitic or made of at least 75% of equiaxed ferrite, from 5 to 20% of martensite and bainite in amount less than or equal to 10%.

Once the part is manufactured, it is assembled to other parts of the vehicle through spot welding. However, the welding of aluminum based coated hardened parts is difficult to realize. In particular, such material does usually not allow a wide welding range. The suitable welding current range is from the current under which a minimum nugget diameter is formed to that under which expulsion occurs. A wide welding current range is desirable because it is possible to control the nugget diameter within a prescribed range even if welding current fluctuates. A wide welding current range is also helpful because it means material is more resistant to electrode wear, misfit, and power line voltage fluctuation. The usual requirement from carmakers is to have a welding range equal or above 1 kA, to be able to run their welding lines with a good quality of welds and without having to change the welding electrodes too often.

Moreover, it was observed that the welding range of press-hardened parts depends on the press hardening parameters used to produce them. The higher the temperature and the time used for press hardening, the smallest the welding range will be. This is due to the presence of surface oxides generated by the press hardening process.

Thus, the purpose of the present invention is to provide a welding method for the manufacture of coated press hardened parts that allows increasing the welding range up to at least 1 kA and minimizes welding expulsion, independently of the press hardening parameters, while maximizing the electrode lifespan.

The present invention provides a welding method for the manufacture of an assembly of at least two steel substrates (3, 3′) spot welded together through at least one spot welded joint, comprising the following steps:
A. The provision of at least two metallic substrates (3, 3′) wherein a first steel substrate (3) is a press hardened steel part obtained by press hardening of a steel sheet coated, said coating containing by weight, before press hardening, from 7 to 12 wt. % of silicon, from 2 to 5 wt. % of iron, optionally additional elements chosen from Sr, Sb, Pb, Ti, Ca, Mn, Sn, La, Ce, Cr, Zr or Bi, the content by weight of each additional element being inferior to 0.3 wt. % and optionally residuals elements, the balance being aluminum,
B. The application of a spot-welding cycle with a spot-welding machine, comprising welding electrodes (1,1′) and a spot-welding power source (2) applying a current, through the at least two metallic substrates of step A, said spot welding cycle (21) consisting of:
   at least three pulsations (22, 32, 42), each having the same maximum pulsation current (Cp) applied through said at least two metallic substrates joined together using welding electrodes connected to the spot-welding power source, each pulsation duration p being identical and set from 20 to 60 ms,
   each pulsation being followed by the same cooling time c set from 30 to 50 ms,
   wherein the welding parameter Wp value is at least 0.8, Wp being defined as

$$Wp = ( t \times c ) / p$$

t being the average thickness of the substrate in mm,
c being the cooling time in ms,
p being the pulsation duration in ms.

### BRIEF DESCRIPTION OF THE DRAWINGS

Other characteristics and advantages of the invention will become apparent from the following detailed description of the invention.

To illustrate the invention, various embodiments and trials of non-limiting examples will be described, particularly with reference to the following figures:

FIG. 1 illustrates an equipment to carry out the present invention.

FIG. 2 illustrate an example of spot-welding cycle according to the present invention.

### DETAILED DESCRIPTION

The invention relates to a welding method for the manufacture of an assembly of at least two steel substrates spot welded together through at least one spot welded joint.

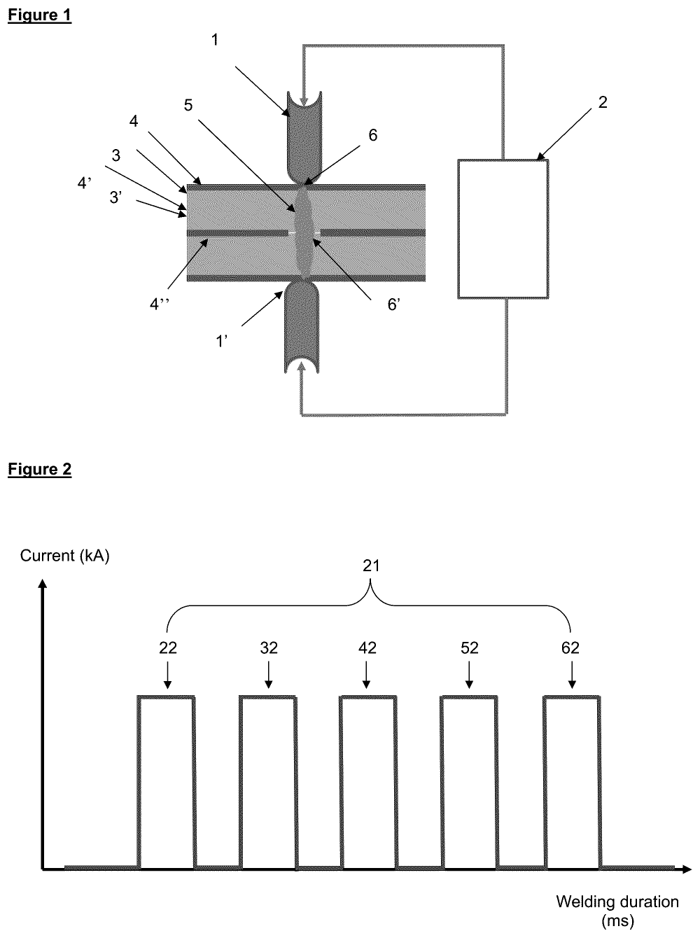

As illustrated in FIG. 1, a spot-welding machine (comprising welding electrodes 1, 1′ and a spot-welding source 2, is used. In this example, the electrodes permit joining of two press-hardened steel parts 3, 3′ manufactured by press hardening of a steel sheet coated with an aluminium based coating 4, 4′, 4″. During the welding, a nugget 5 is formed between the two press-hardened steel parts through diffusion, ultimately forming a spot welded joint 6, 6′. The current can be alternative current (AC) or direct current (DC). In a preferred embodiment, the current is mid frequency direct current (MFDC) obtained by conversion of AC current supply.

The method according to the invention further comprises the application of a spot-welding cycle 21, consisting of:
at least three pulsations 22, 32, 42, each having the same pulsation current (Cp) applied through the metallic substrates joined together using welding electrodes connected to the spot-welding power source, each pulsation duration p being identical and set from 20 to 60 ms,
each pulsation being followed by the same cooling time c set from 30 to 50 ms,
   wherein the welding parameter Wp value is at least 0.8, Wp being defined as

$$Wp = ( t \times c ) / p$$

t being the thickness of the substrate in mm,
c being the cooling time in ms,
p being the pulsation duration in ms.

The pulsations used in the method according to the invention must be present in a number of at least three and preferably at least five. In a preferred embodiment, the maximum number of pulsations can be set to nine of them. After using such pulsations separated by such cooling times, the substrates are fully welded, meaning that no other welding cycle of any kind is performed in addition to them.

Their duration p is identical from one pulsation to the others and is set within a range going from 20 to 60 ms, preferably from 30 to 50 ms.

The maximum pulsation current (Cp) of all pulsations is identical and is preferably set from 0.1 to 30 kA, while the welding method is preferably set from 50 to 650 daN and more preferably from 250 to 500 daN.

The welding intensity is preferably set from 500 to 5000 Hz and more preferably from 800 to 2000 Hz.

The spot-welding cycle according to the present invention can include pulsations with current setpoint of various forms. Such pulsations can be identical in a given welding cycles or can be different. FIG. 2 illustrates one preferred embodiment wherein the spot-welding cycle 21 consists of pulsations setpoints with a rectangular form, namely identical rectangular pulsations peaks 22, 32, 42, 52 and 62. Other options of setpoint forms for such pulsations are:
a parabolic form,
a triangular form
   or any other suitable form, provided that the pulsations of a given welding cycle all have the same maximum pulsation current (Cp).

Between each pulsation of the welding cycle according to the invention, a specific cooling time c must be respected to reduce early expulsions that would significantly decrease the welding range. Such cooling time is set from 30 to 50 ms. Moreover, the welding parameter Wp value is at least 0.8, preferably at least 0.9 or even better at least 1.0, Wp being defined as

$$Wp = ( t \times c ) / p$$

t being the average thickness of the substrate in mm,
c being the cooling time in ms,
p being the pulsation duration in ms.

The setting of the value of this welding parameter Wp which takes into account the thickness of the substrate contributes to obtain the improvement in welding properties that are targeted by the invention.

In the frame of the invention, the term press-hardened steel part refers to a hot-formed or hot-stamped steel part having a tensile strength up to 2500 MPa, and more preferably up to 2000 MPa, after austenitisation of a blank and further forming and quenching in a die. For example, the tensile strength is above or equal to 500 MPa, advantageously above or equal to 1200 MPa, preferably above or equal 1500 MPa.

The method according to the invention applies to press hardened steel part obtained by press hardening of a steel sheet coated with the so-called AlSi coating. Said coating comprises 7 to 12 wt. % of silicon, 2 to 5 wt. % of iron, optionally additional elements chosen from Sr, Sb, Pb, Ti, Ca, Mn, Sn, La, Ce, Cr, Zr or Bi, the content by weight of each additional element being inferior to 0.3 wt. % and optionally residuals elements, the balance being aluminum.

The press-hardening processing of such steel sheets is well known to the person skilled in the art and includes an austenization of a blank cut out of such steel at a temperature that can, for example, from 880 to 950° C., preferably from 900 to 950° C., during 3 to 10 minutes, preferably during 6 to 10 minutes, followed by a quenching in the forming die. After press-hardening, the aluminium coatings described above will get alloyed by diffusion of iron due to the heating of the blanks.

The average thickness of the steel substrate can, for example, range from 0.8 to 3 mm, preferably from 1 to 2 mm.

The welding method according to the invention can be used to weld such a press-hardened to a similar press-hardened part (homogenous welding) or to any steel part. It can also be used in a hybrid welding between a press-hardened steel part and an aluminum substrate.

The invention will now be explained in trials carried out for information only. They are not limiting.

### EXAMPLES

Steel sheets of different compositions and average thicknesses coated with aluminium based alloys were prepared and press hardened under the conditions gathered in table 1.

TABLE 1

| | | Thickness | | | | |
|---|---|---|---|---|---|---|
| | | of the steel | | Coating | Duration of | Temperature |
| | Steel | sheet t | | weight | press | of press |
| Trial | sheet type | (mm) | Coating | (g/m²) | hardening (s) | hardening (° C.) |
| 1 | U1500 | 2.0 | AlSi | 150 | 360 | 930 |
| 2 | U1500 | 1.8 | AlSi | 150 | 520 | 925 |
| 3 | U1500 | 1.8 | AlSi | 150 | 520 | 925 |
| 4 | U1500 | 1.8 | AlSi | 150 | 520 | 925 |
| 5 | U1500 | 1.8 | AlSi | 150 | 520 | 925 |
| 6 | U1500 | 1.8 | AlSi | 150 | 520 | 925 |
| 7 | U1500 | 1.4 | AlSi | 150 | 540 | 950 |
| 8 | U1500 | 1.4 | AlSi | 150 | 540 | 950 |
| 9 | U1500 | 1.4 | AlSi | 150 | 540 | 950 |
| 10 | U1500 | 1.2 | AlSi | 150 | 480 | 950 |
| 11 | U1500 | 1.2 | AlSi | 150 | 480 | 950 |
| 12 | U1500 | 1.2 | AlSi | 150 | 600 | 940 |
| 13 | U1500 | 1.0 | AlSi | 150 | 480 | 930 |
| 14 | U1500 | 1.0 | AlSi | 150 | 480 | 930 |
| 15 | U1500 | 1.0 | AlSi | 150 | 600 | 920 |
| 16 | U1500 | 1.0 | AlSi | 150 | 480 | 930 |
| 17 | U1500 | 1.0 | AlSi | 150 | 480 | 930 |
| 18 | U1500 | 1.0 | AlSi | 150 | 480 | 930 |

U1500 has a composition of 0.22 wt. % of carbon, 1.2 wt. % of manganese, 0.25 wt. % of silicon, 0.2 wt. % of chromium, 0.04 wt. % of aluminium, 0.04 wt. % of titanium and 0.003 wt. % of boron.

AlSi coating comprises 9% by weight of silicon, 3% by weight of iron, the balance being aluminum.

Then, for each trial, two identical press hardened parts were welded together. The welding range was determined using standard ISO 18278-2:2016. Welding test started from a low current such as 3 kA and increased by 0.2 kA, two spot welds being made for each current level. When both welds met the minimum size requirement of 4√t, where t is the sheet thickness, a third weld was made at the same current lmin, so all three welds are at or above 4√t. This criterion defines the minimum acceptable diameter value of the nugget that guaranteed the weld quality and strength. The current intensity was then increased further by 0.2 kA steps, until two out of three consecutive welds had splashing occurring at the same current level. This current level is defined as the upper welding limit of the current range lexp. The welding range is then calculated as being (lexp−lmin). The pulsations setpoints were of rectangular form.

The frequency was set to 1000 Hz and the welding force was set according to ISO 18278-2:2016 for various thicknesses from 350 daN to 500 daN. The results of the trials are gathered in Table 2.

TABLE 2

| | Electrode | | | | | | |
|---|---|---|---|---|---|---|---|
| | tip | | | Duration of | Cooling | Welding | Welding |
| | diameter | Gap | Number of | pulsation | time c | parameter | range |
| Trials | (mm) | (mm) | pulsations | p (ms) | (ms) | Wp | (kA) |
| 1* | 8 | 0 | 4 | 55 | 30 | 1.09 | 2.6 |
| 2* | 8 | 0 | 5 | 50 | 33 | 1.08 | 2.6 |
| 3* | 6 | 0 | 5 | 50 | 33 | 1.19 | 2.1 |
| 4* | 8 | 1.4 | 5 | 50 | 33 | 1.19 | 1.6 |
| 5* | 6 | 1.4 | 5 | 50 | 33 | 1.19 | 1.3 |
| 6 | 8 | 0 | 1 | 416 | 0 | 0 | 0 |
| 7* | 6 | 0 | 5 | 50 | 33 | 0.92 | 1.45 |
| 8 | 6 | 0 | 1 | 380 | 0 | 0 | 0.6 |
| 9* | 6 | 0 | 7 | 40 | 30 | 1.05 | 1.4 |
| 10 | 6 | 0 | 5 | 50 | 30 | 0.72 | 0.6 |
| 11* | 6 | 0 | 8 | 35 | 30 | 1.03 | 1.8 |
| 12* | 6 | 0 | 8 | 35 | 30 | 1.03 | 1.4 |
| 13 | 6 | 0 | 1 | 380 | 0 | 0 | 0.8 |
| 14* | 6 | 0 | 9 | 30 | 30 | 1.00 | 1.6 |
| 15* | 6 | 0 | 9 | 30 | 30 | 1.00 | 1.4 |
| 16 | 6 | 0 | 5 | 50 | 30 | 0.60 | <0.6 |
| 17 | 6 | 0 | 4 | 40 | 20 | 0.50 | <0.6 |
| 18 | 6 | 0 | 9 | 30 | 20 | 0.67 | 0.8 |

*according to the present invention;
underlined values: not according to the invention

Trials 6, 8, 10, 13, 16, 17 and 18 were not weldable, i.e. the welding range defined in the standard ISO 18278-2 was not achieved. Trials according to the present invention all have a welding range equal or above 1 kA, even for parts produced with very high press hardening temperatures and time as demonstrated notably by trials 7, 9 and 11.

Moreover, it was observed that the electrode lifespan was drastically improved when using the method according to the invention, the electrodes being able to perform more than 1000 welding cycles to be compared with 100 welding cycles for conventional methods.

What is claimed is:

1-8. (canceled)

9. A welding method for manufacturing an assembly of at least two substrates spot welded together through at least one spot welded joint, the method comprising the following steps:
A. providing a steel first substrate and a second substrate, the first steel substrate being a press hardened steel part obtained by press hardening of a steel sheet coated with a coating, the coating containing by weight, before press hardening, from 7 to 12 wt. % of silicon, from 2 to 5 wt. % of iron, optionally additional elements chosen from Sr, Sb, Pb, Ti, Ca, Mn, Sn, La, Ce, Cr, Zr or Bi, a content by weight of each additional element being inferior to 0.3 wt. % and optionally residuals elements, a balance being aluminum,
B. applying a spot-welding cycle with a spot-welding machine, comprising welding electrodes and a spot-welding power source applying a current, through the first and second substrates, the spot welding cycle including:
at least three pulsations, each having a same maximum pulsation current applied through the first and second substrates joined together using welding electrodes connected to the spot-welding power source, each pulsation duration p being identical and set from 20 to 60 ms,
each pulsation being followed by a same cooling time c set from 30 to 50 ms, wherein a welding parameter Wp value is at least 0.8, Wp being defined as
$$Wp = ( t \times c ) / p$$
t being the average thickness of the substrate in mm,
c being the cooling time in ms, and
p being the pulsation duration in ms,

10. The welding method as recited in claim 9 wherein the maximum pulsation current is set from 0.1 to 30 kA.

11. The welding method as recited in claim 9 wherein a number of the at least three pulsations is set from three to nine.

12. The welding method as recited in claim 9 wherein a welding force is set from 50 to 650 daN.

13. The welding method as recited in claim 9 wherein a welding frequency is set from 500 to 5000 Hz.

14. The welding method as recited in claim 9 wherein the pulsations have a setpoint shape selected among:
a rectangular form,
a parabolic form,
a triangular form.

15. The welding method as recited in claim 9 wherein the second metallic substrate is a steel substrate.

16. The welding method as recited in claim 15 wherein the second steel substrate is a press hardened steel part.

17. The welding method as recited in claim 9 wherein the second metallic substrate is an aluminum substrate.
